(19) United States
(12) Patent Application Publication
(10) Pub. No.: US 2007/0001027 A1
(43) Pub. Date: Jan. 4, 2007

(54) Fuel injector valve

(76) Inventor: Hubert Stier, Vaihingen/Enz (DE)

Correspondence Address: KENYON & KENYON LLP, ONE BROADWAY, NEW YORK, NY, 10004, US

(21) Appl. No.: 10/554,270

(22) PCT Filed: Feb. 24, 2004
(86) PCT No.: PCT/DE04/00335

§ 371 Date: Aug. 25, 2006

(30) Foreign Application Priority Data
Apr. 24, 2003 (DE) 103 18 639.5

(51) Int. Cl. B05B 1/08

(52) U.S. Cl. 239/102.2; 239/456

(57) ABSTRACT

A fuel injector, in particular a fuel injector for fuel-injection systems of internal combustion engines, includes a piezoelectric or magnetostrictive actuator which is excitable via an electrical line and actuates a valve-closure member, which is arranged in a housing and cooperates with a valve-seat surface to form a sealing seat, and an hydraulic coupler. The hydraulic coupler has a downstream recess in which one end of a valve needle is engaged in a pivotable manner.

### BACKGROUND INFORMATION

German Patent Application No. DE 35 33 085, describes a metering valve for the metering of fluids or gases, especially an injection valve for fuel-injection systems in internal combustion engines, which has a piezo stack actuator whose linear deformation in response to the application of an excitation voltage is transmitted to a valve needle which controls a metering orifice and determines the valve lift of the valve needle. The substance to be metered is supplied via a supply line which is formed in the valve body in the form of a deep-hole bore.

A disadvantage of the metering valve described in German Patent Application No. DE 35 33 085 is that there is no possibility of compensating offsets of the valve needle, which is rigidly joined to the actuator in an operative connection. This may lead to malfunctions of the metering valve.

### SUMMARY OF THE INVENTION

The fuel injector according to the present invention has the advantage that the hydraulic coupler has a recess at a side facing the valve needle in which the correspondingly formed valve needle engages. The recess is designed in such a way that angular offsets are able to be compensated.

In an advantageous manner, the valve needle is rounded and the recess is conical. Due to a circular contact line, offsets are able to be compensated in a reliable and simple manner.

Furthermore, it is advantageous that the arrangement is able to be produced in a very simple manner and requires no additional components.

### BRIEF DESCRIPTION OF THE DRAWINGS

FIG. 1 shows a schematic section through the discharge-side end of an exemplary embodiment of a fuel injector configured according to the present invention.

FIG. 2 shows a cutaway view, in region II in FIG. 1, of the tiltable suspension of the coupler between actuator and valve needle of the fuel injector configured according to the present invention.

### DETAILED DESCRIPTION

In the following, an exemplary embodiment of the present invention is described by way of example. In this context, corresponding components are provided with the same reference numerals in all of the figures.

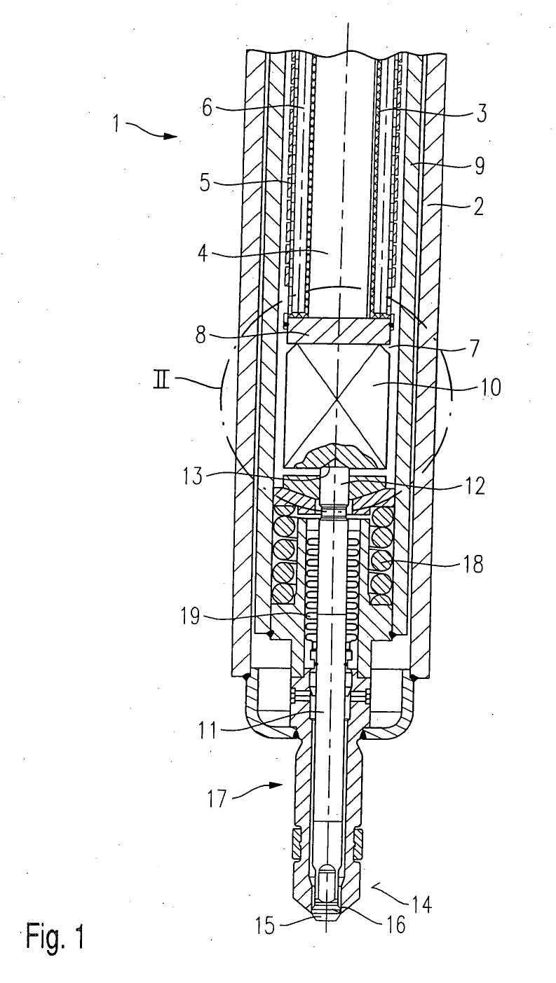

A fuel injector 1 represented in FIG. 1 is configured in the form of a fuel injector for fuel-injection systems of mixture-compressing internal combustion engines with externally supplied ignition. Fuel injector 1 is especially suited for the direct injection of fuel into a combustion chamber (not shown) of an internal combustion engine.

Fuel injector 1 includes a housing 2 in which a piezoelectric or magnetostrictive actuator 4 is arranged which is provided with an actuator extrusion coat 3. Actuator 4 is prestressed by a tubular spring 5 to allow a non-destructive installation and a reproducible actuation of actuator 4. An electrical voltage may be supplied to actuator 4 via an electrical line 6. On the inflow side, actuator 4 is braced on an actuator base (not shown further) and on the downstream side it is supported on an actuator head 8. Actuator 4 is encapsulated in a valve housing 9.

Downstream from actuator 4, fuel injector 1 has an hydraulic coupler 10. Hydraulic coupler 10 is configured as secondary-medium coupler 10 and is shown as an overall component in the present exemplary embodiment for reasons of clarity. An hydraulic coupler 10 usually includes a master piston and a slave piston, which are mutually acted upon by a coupler spring. Hydraulic coupler 10 may be sealed from an interior 7 of fuel injector 1 by a corrugated-tube-shaped seal, for example.

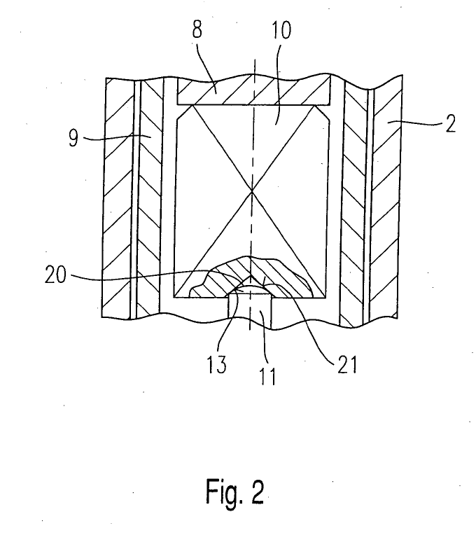

Hydraulic coupler 10 rests against a valve needle 11. An inflow-side end 12 of valve needle 11 has a hemispherical design and is positioned in a recess 13 of hydraulic coupler 10. The inflow-side end 12 of valve needle 11 and hydraulic coupler 10 are shown enlarged in FIG. 2 and described in detail below.

At its downstream-side end 14, valve needle 11 has a valve-closure member 15 which cooperates with a valve-seat surface 16 to form a sealing seat. Shown in the exemplary embodiment is an outwardly opening fuel injector 1.

Valve needle 11 is guided in a multi-part nozzle body 17 and acted upon by a restoring spring 18, which simultaneously prestresses actuator 4. Restoring spring 18 is arranged in actuator housing 9. In the exemplary embodiment, the sealing of actuator housing 9 from interior 7 of fuel injector 1 is likewise implemented with the aid of a corrugated tube-shaped seal 19.

In a part-sectional view, FIG. 2 shows the detail designated by II in FIG. 1 of fuel injector 1 configured according to the present invention.

As already mentioned, the inflow-side end 12 of valve needle 11 is rounded. A rounded region 20 of end 12 may be in the shape of a cap or hemisphere. Recess 13 in hydraulic coupler 10 has a conical design. Rounded region 20 abuts along a circular contact line 21 in recess 13 which allows an even absorption of the forces. The arrangement provides for the compensation of offsets of valve needle 11 during operation of fuel injector 1 in a simple and reliable manner. Such offsets may otherwise lead to malfunctions of fuel injector 1 due to jamming of valve needle 11, or to the destruction of actuator 4 because of shear forces in offsets. The arrangement shown is characterized by an especially uncomplicated producibility. In particular, no additional components are required.

The present invention is not restricted to the exemplary embodiment shown but suitable for various designs of fuel injectors 1.

1-6. (canceled)

7. A fuel injector comprising:
a housing;
a valve-seat surface;
a valve needle;
a valve-closure member situated in the housing and cooperating with the valve-seat surface to form a sealing seat;
one of a piezoelectric and magnetostrictive actuator which actuates the valve-closure member; and
an hydraulic coupler having a downstream recess in which one end of the valve needle is engaged in a pivotable manner.

8. The fuel injector according to claim 7, wherein the recess has a conical shape.

9. The fuel injector according to claim 7, wherein the recess widens in a discharge direction.

10. The fuel injector according to claim 7, wherein an inflow-side end of the valve needle has a rounded region.

11. The fuel injector according to claim 10, wherein the rounded region is in a shape of one of a cap and a hemisphere.

12. The fuel injector according to claim 10, wherein the rounded region rests in the recess by way of a circular contact line.

13. The fuel injector according to claim 7, wherein the fuel injector is for a fuel-injection system of an internal combustion engine.
